(19) United States
(12) Patent Application Publication
(10) Pub. No.: US 2026/0266258 A1
(43) Pub. Date: Sep. 10, 2026

(54) LINEAR DARRIEUS VERTICAL-AXIS WIND POWER GENERATION APPARATUS CAPABLE OF LARGE-SCALE MANUFACTURE

(71) Applicants: JEOMHEE KIM, Gyeongsangbuk-do (KR); PHC CO., Ltd, Daegu (KR)

(72) Inventor: JEOMHEE KIM, Gyeongsangbuk-do (KR)

(21) Appl. No.: 19/559,267

(22) Filed: Mar. 6, 2026

(30) Foreign Application Priority Data
Mar. 7, 2025 (KR) 10-2025-0029521

(51) Int. Cl. F03D 3/00; F03D 7/06; F03D 15/10

(52) U.S. Cl. CPC F03D 3/011; F03D 7/06; F03D 15/10; F05B 2260/902

(57) ABSTRACT

The present invention relates to a straight-bladed Darrieus vertical-axis wind turbine. A cylindrical inner rotating shaft is vertically supported by upper and lower bearings, and a frustum-shaped outer stationary shaft surrounding a lower portion of the rotating shaft is eccentrically and inclinedly arranged to define an enlarged machine-room space in a lower region of the turbine. A power take-off gear and a brake disc are disposed at the lower portion of the rotating shaft to enable efficient resistance to bending loads and to facilitate large-scale implementation. One or more brake discs having a brake-disc wall are fixed to the lower portion of the inner rotating shaft and are clamped by at least one brake caliper, and a braking/output control device including a water supply device is provided to effectively control excessive power output.

### CROSS-REFERENCE TO RELATED APPLICATION(S)

This application is based on and claims priority under 35 U.S.C. 119 to Korean Patent Application No. 10-2025-0029521, filed on March 07, 2025, in the Korean Intellectual Property Office, the disclosure of which is herein incorporated by reference in its entirety.

### BACKGROUND OF THE INVENTION

### Field of the invention

The present invention relates to a linear Darrieus vertical-axis wind power generation apparatus having a vertical axis. More particularly, the present invention relates to a vertical-axis wind power generation apparatus devised to secure a large space in a lower portion of the vertical axis so that the space can be used as a machine room, to efficiently respond to bending forces, to enable implementation of a large vertical-axis wind turbine by improving a large-blade supporting method, and to effectively control excess output.

### Description of the Prior Art

As is well known, vertical-axis wind turbines wind power generators have many advantages over horizontal-axis wind turbines, yet their adoption has been sluggish. In particular, while the trend toward larger wind turbines has progressed in recent years, the reality is that large vertical-axis wind turbines have not been constructed at all due to various problems associated with scaling up.

A Savonius vertical-axis wind turbine that utilizes a drag difference according to the blade shape has no starting problem; however, its efficiency per swept area is only about 25 percent of the efficiency of a horizontal-axis wind turbine, so it has no value for power generation and can be used only in special cases.

A Darrieus vertical-axis wind turbine using lift has difficulty in self-starting, but its efficiency reaches about 85 percent of that of a horizontal-axis wind turbine. Considering its various advantages, it has sufficient value; however, it has not been widely adopted due to several problems.

Advantages of vertical-axis wind turbines include that yawing azimuth control is unnecessary, mechanical devices are located close to the ground so maintenance is easy, installation of large mechanical devices is possible, and thus they are particularly suitable for offshore wind power generation in which maintenance of machinery located at a high position is more difficult. Further advantages include ease of treatment in emergencies such as fire, insensitivity to sudden changes in wind direction, low noise because there is no high-speed portion such as a blade tip of a horizontal-axis wind turbine and the rotational speed is relatively low, reduced bird-collision damage, and the possibility of denser arrangement than horizontal-axis wind turbines.

It is also a significant advantage that, as in the present invention, it is easy to install a large output-control device that converts excess output into thermal energy.

In offshore wind power, a horizontal-axis wind turbine suffers the disadvantage that bending of the tower below the water surface increases. In contrast, in a vertical-axis wind turbine, an external fixed shaft is used as a tower and the interior thereof is used as a machine room, so the increase in bending is not large.

Many experts predicted that a major change would occur in the wind turbine market and that vertical-axis wind turbines would become dominant, but this prediction has not yet been realized. The present invention aims to realize this prediction.

An egg-shaped curved Darrieus wind turbine is a mechanically excellent structure because the centrifugal force and tensile force of the blades cancel each other. However, due to its shape, the swept area is small, and support by a wire or rope at an upper portion of the axis is inevitable, making vibration likely to occur. Such vibration can lead to bearing failure. In addition, due to the wire and the wire foundation, the installation area becomes excessive, and residual land use at a lower portion of the wind turbine is hindered.

In wind power generation, less than 1 percent of the required site area is needed for the facilities, and the remaining 99 percent or more can be used for farmland, pasture, salt fields, solar power generation, and the like. This is a decisive advantage of wind power generation, and reducing this advantage is undesirable.

Also, an upper-axis support wire prevents utilization of an upper portion of the blades where wind conditions are favorable.

A linear Darrieus wind turbine having vertically oriented blades is advantageous in that mass production and processing of blades are easy, the swept area is large, the installation area is small due to a self-supporting tower, residual land use is easy, an upper portion of the blades where wind conditions are favorable can be utilized, and blade pitch angle adjustment is possible. However, when scaled up, it is difficult to support the blades, blade supports struts or arms consume power generated by the blades, and, as in horizontal-axis wind turbines, a large bending occurs at a lower portion of the tower fixed shaft.

### Prior Art Documents

### Patent Documents

(Patent Document 0001) : Korean Patent Publication No. 10-2011-0016655 (Feb. 18, 2011)

### SUMMARY OF THE INVENTION

To date, there has been virtually no definitive model for supporting a large linear Darrieus wind turbine or arranging a large machine room.

In contrast, although a curved Darrieus wind turbine has the problems described above, its supporting method has been established.

This is a major reason why large linear Darrieus wind turbines have not been widely adopted despite their many advantages.

A support strut or arm connecting the blades and the rotating shaft is typically a horizontal circular tube, which generates large bending, making it difficult to lengthen and scale up. In addition, because the drag coefficient is large, a significant amount of power generated by the blades is consumed.

The support is a critical weakness of a linear Darrieus wind turbine.

Difficulty in self-starting is also a problem, as with other Darrieus wind turbines.

Although output control is possible by adjusting the blade pitch angle, pitch angle adjustment itself is difficult, expensive, and difficult to maintain.

In order to solve the above problems, the present invention provides a configuration in which a cylindrical internal rotating shaft supported by an upper bearing and a lower bearing is eccentrically installed inside an inclined circular truncated cone-shaped external fixed shaft of a linear Darrieus wind turbine. A large lower space formed by the eccentric installation is used as a machine room. A large cross-sectional area and a large section modulus of a lower portion of the external fixed shaft resist large bending. The internal rotating shaft and the blades serve as chord members, and a strut or arm having an elliptical or streamlined cross-section with a small drag coefficient serves as a web member, thereby forming a vertical Warren truss to support the blades and reduce power consumption. Further, ends of the blade supports are mutually connected by wires to reduce horizontal bending of the supports, thereby enabling manufacture of a large vertical-axis wind turbine.

In addition, by appropriately clamping a brake disk fixed to the internal rotating shaft with a caliper and converting excess output into thermal energy, output rotational speed can be controlled in a simple manner, thereby avoiding complicated and difficult output control methods such as blade pitch adjustment or an air brake. If necessary, an additional large output control apparatus can be installed in the spacious machine room.

As described above, the present invention enables efficient and relatively simple installation of a large vertical-axis wind power generation apparatus having advantages such as easy maintenance, capability of installing a large mechanical apparatus, insensitivity to sudden changes in wind direction, low noise, and capability of dense arrangement.

In particular, by configuring an external fixed shaft in an eccentrically arranged truncated cone form, a machine room can be provided. Further, by connecting the rotating shaft and the blades through a vertical Warren truss having an elliptical or streamlined cross-section with a small drag coefficient, power consumption is reduced and a large vertical-axis wind turbine capable of efficiently responding to bending forces can be implemented. In addition, there is an advantage that output can be effectively controlled by converting excess output into thermal energy.

Further, by connecting the supports to vertical Savonius blades, self-starting becomes possible. At the same time, the supports are vertically reinforced, and portions near ends of the supports are mutually connected by wires to horizontally reinforce the supports, thereby enabling large-scale manufacture.

### BRIEF DESCRIPTION OF THE DRAWINGS

FIG. 1A is an exemplary diagram illustrating an overall configuration of the present invention.

FIG. 1B is an exemplary diagram illustrating another embodiment of the present invention.

FIGS. 2A and 2B are plan views of the present invention.

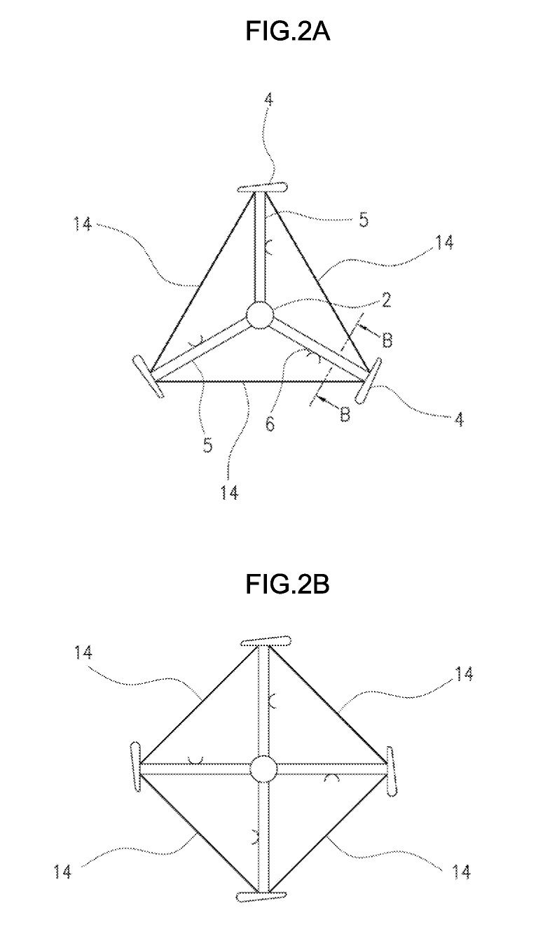

FIG. 3 is an exemplary cross-sectional view taken along line A-A of FIG. 1A.

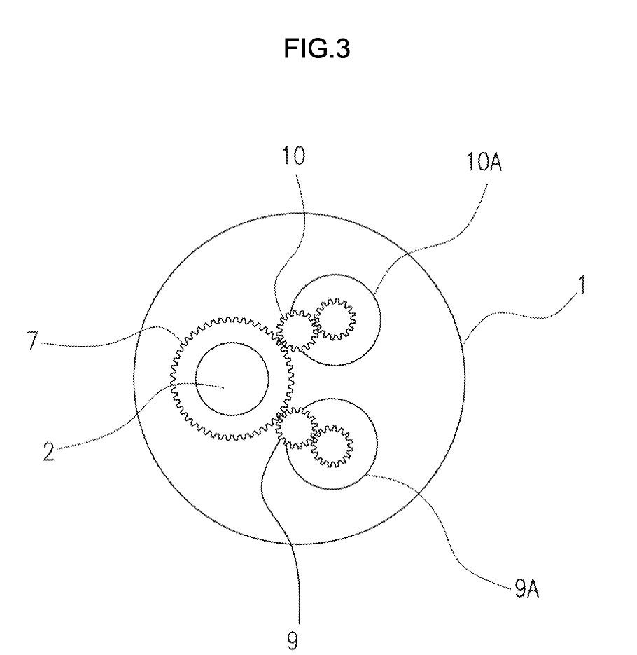

FIGS. 4A to 4C are exemplary cross-sectional views taken along line B-B of FIG. 2A.

FIG. 5 is an exemplary diagram illustrating a configuration of a brake and output control device of the present invention.

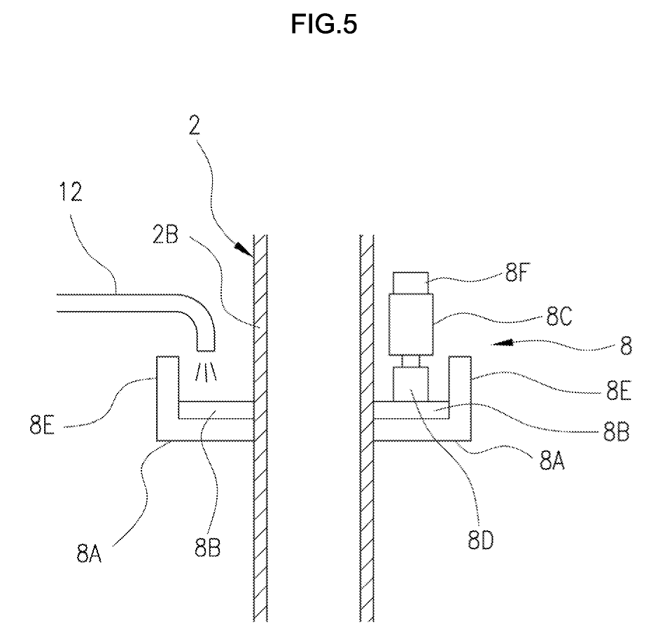

### DETAILED DESCRIPTION OF THE EXEMPLARY EMBODIMENTS

Hereinafter, a configuration of the “linear Darrieus vertical-axis wind power generation apparatus capable of large-scale manufacture” according to the present invention will be described in detail. This description is based on embodiments for implementing the present invention and is not intended to limit the technical spirit pursued by the present invention to the forms described herein. It should be understood that various modifications, equivalents, and/or alternatives of the embodiments of the present invention are included.

In addition, even if operational effects according to the configuration of the present invention are not explicitly described, effects predictable from the configuration should naturally be recognized.

An inclined truncated cone-shaped external fixed shaft 1 is a core of the present invention. An internal rotating shaft 2 is installed vertically, and the external fixed shaft 1 surrounding a lower portion of the internal rotating shaft 2 has a truncated cone shape, with a portion of a lower end embedded in a concrete foundation 13. Unlike the internal rotating shaft 2 installed vertically, the truncated cone-shaped external fixed shaft 1 is installed to have an inclination, such that one generatrix line of the external fixed shaft 1 close to the internal rotating shaft 2 has a steep slope approaching perpendicular to the centerline of the internal rotating shaft 2, while the opposite side has a relatively gentle slope. As a result, a large space is secured on one gentle side surface portion between the internal rotating shaft 2 and the external fixed shaft 1.

Accordingly, by securing a large cross-sectional area and a large section modulus of the external fixed shaft 1 near the concrete foundation 13, a large overturning moment can be resisted, and a large space between a lower portion of the external fixed shaft 1 and a lower portion 2B of the internal rotating shaft 2 can be used as a machine room.

Due to the inclination of the external fixed shaft 1, the section modulus is slightly reduced compared to a non-inclined regular truncated cone; however, this disadvantage can be regarded as negligible because it is not comparable to the benefit of securing a large machine room.

In the case of a monopile offshore wind turbine, a space between an upper surface of the concrete foundation 13 and the water surface can also be used as the machine room and the external fixed shaft 1. Therefore, an increase in bending moment due to tower height below the water surface is small. This is why the present invention is particularly suitable for offshore wind power generation in shallow seas.

Since an upper portion of the external fixed shaft 1 for supporting the internal rotating shaft 2 is inclined, an upper bearing 3A for the rotating shaft cannot be installed vertically. Therefore, an upper adapter 1B of the external fixed shaft, which is a low-angle elbow, is joined to an upper end of the external fixed shaft 1 so that an upper part thereof becomes a horizontal circle concentric with the internal rotating shaft 2, and then the upper bearing 3A is installed between the adapter and the internal rotating shaft 2.

A lower portion of the internal rotating shaft 2 is supported by a lower bearing 3B fixed to the concrete foundation 13 or the external fixed shaft 1.

An upper portion 2A of the internal rotating shaft above the upper bearing 3A and linear Darrieus blades 4 are connected by elliptical or streamlined supports 5 struts or arms, such that the internal rotating shaft 2 and the blades 4 serve as chord members and the supports 5 serve as web members, thereby forming a vertical Warren truss.

A truss structure is the most effective structure for supporting loads, and among them, a Warren truss is the simplest. With this structure, the large linear Darrieus blades 4 can be supported.

Further, an upper end of the blades is extended upward by an amount equal to the vertical height of an uppermost support 5 web member plus the blade height above a joint portion between the uppermost support 5 and the blade, and a lower end of the blades is extended downward by an amount equal to the vertical height of a lowermost support 5 plus the blade height below a joint portion between the lowermost support 5 and the blade. Thus, the swept area increases by that amount, which is a significant advantage.

The swept area of an upper portion of the blades where wind conditions are favorable can be greatly expanded, and wind near the ground at a lower portion of the blades, which is difficult to utilize in horizontal-axis wind turbines due to turbulence and the like, can also be fully utilized. This is because vertical-axis wind turbines are not significantly affected by turbulence or sudden changes in wind direction.

It is also important that the length of the internal rotating shaft 2 is reduced by the amount of the increased upper blade length.

The number of the linear Darrieus blades 4 is not limited, but typically three or four are installed at equal angles.

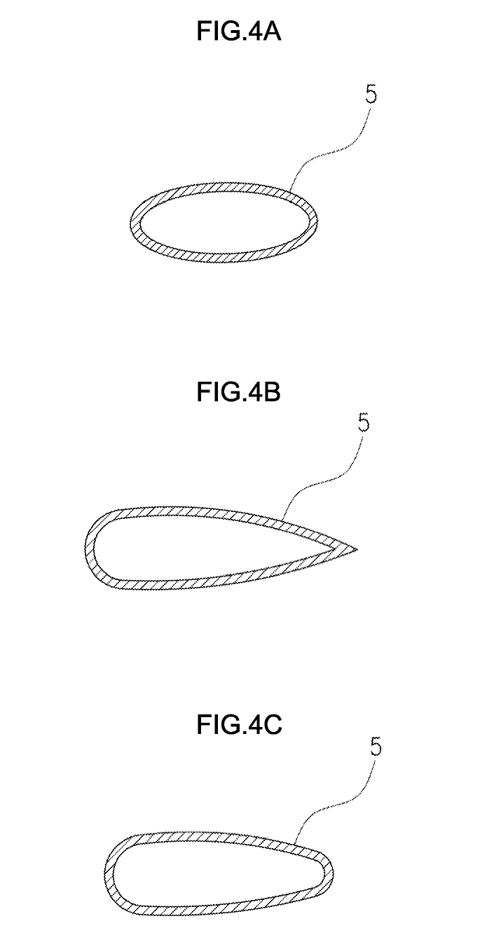

The supports 5 are configured to have an elliptical cross-section having a long radius in a horizontal direction as in FIG. 4A. This reduces a drag coefficient that causes power loss during normal operation, and also effectively resists a large horizontal bending acting when operation is stopped due to a storm, by virtue of a large horizontal section modulus. If the rear portion of the ellipse is extended to be streamlined as in FIG. 4B, the drag coefficient is further reduced, but the horizontal section modulus of the supports 5 decreases. Therefore, it is desirable to find a shape that appropriately compromises between the drag coefficient and the section modulus as in FIG. 4C. Of course, elliptical or streamlined cross-sections are possible.

As in blades of a horizontal-axis wind turbine, an outer side of a support may be streamlined and a portion near the rotating shaft may be elliptical or circular with a large section modulus; however, machining becomes difficult and thus the advantage of mass production is diminished.

If an end portion of the supports 5 joined to the blades is connected to an end portion of an adjacent support by a wire 14 or rope so as to form a triangular or quadrilateral loop shape, the end portion of the supports 5 is also supported in a horizontal direction. Accordingly, horizontal bending of the supports 5 is greatly reduced, thereby enabling extension of the support length. In a vertical direction, since it is a truss structure, bending hardly occurs.

Since tensile stress generated in the wire is small, the wire may be thin. If a connection point of the wire 14 on the supports 5 is located closer to the internal rotating shaft 2, a bending moment at a joint portion between the supports 5 and the rotating shaft is further reduced; however, a bending moment is generated at the connection point of the wire 14, so gains and losses should be carefully considered.

Even if only the end portions of the supports 5 are connected by wires, the bending moment at the joint portions between the supports and the rotating shaft is greatly reduced, and it should also be considered that connecting the wire 14 at the end portions is easy at the blade joint portion.

Power loss due to thin wires 14 is negligible, and the wire cost is also negligible. That is, with a small wire cost, a large effect of increasing bending strength of the supports is obtained, thereby enabling manufacture on a larger scale.

Additional tensile or compressive stress may occur in the supports due to tensile stress of the wires, but it is negligible because the cross-sectional area of the supports is large.

The linear Darrieus blades 4 of the present invention do not differ in shape from general linear Darrieus blades, and only the supporting method is somewhat different. Difficulty in self-starting is a common problem of Darrieus turbines.

As in general Darrieus turbines, the vertical-axis wind power generation apparatus according to the present invention may be started by using a generator also as a motor and starting with an external power source. However, this method has disadvantages in that initial external power is required, control is complicated, and the machine is expensive.

A method of combining Savonius blades for starting is widely used, but some power loss during normal operation is inevitable. There are methods such as providing air pockets to the linear Darrieus blades 4 or additionally installing small horizontal Savonius blades. However, in the present invention, a method of attaching vertical Savonius auxiliary blades 6 is proposed. Power loss during normal operation is similarly inevitable, but there is an effect of vertically reinforcing the supports 5.

In particular, by reducing a buckling length of the supports, compressive buckling strength is increased. By repeatedly reinforcing the supports, which are a weakness of linear Darrieus turbines, using the Warren truss structure, loop-shaped wires, elliptical support cross-sections, and the vertical Savonius auxiliary blades, the support length is extended, thereby enabling a larger scale.

It may be considered to use the supports themselves as Savonius blades, but it is difficult because the section modulus is too small.

Bending of the internal rotating shaft 2 gradually increases from an upper part toward a lower part and becomes maximum at the upper bearing 3A, then gradually decreases toward a lower side and becomes minimum at the lower bearing 3B.

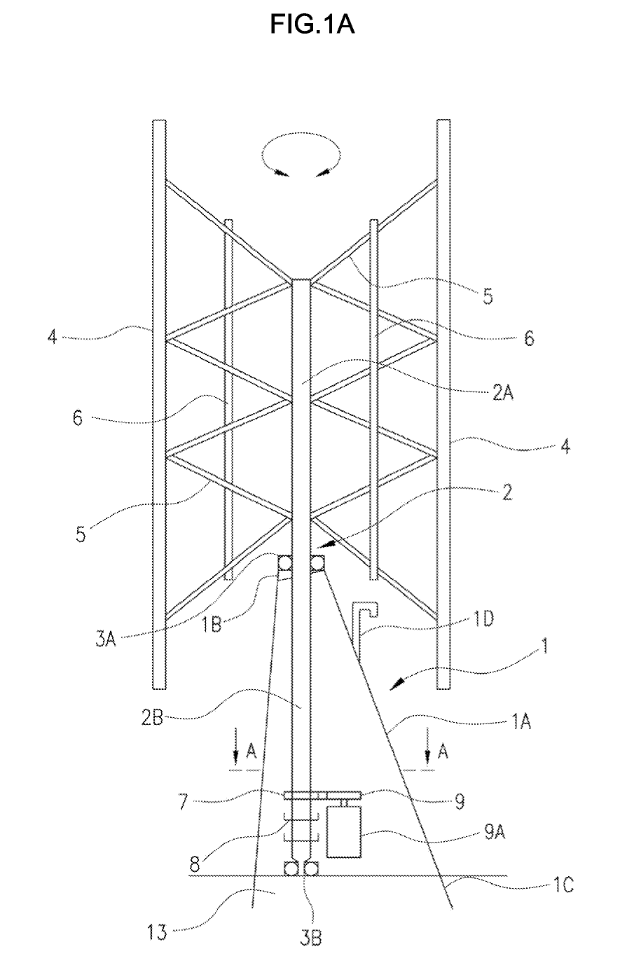

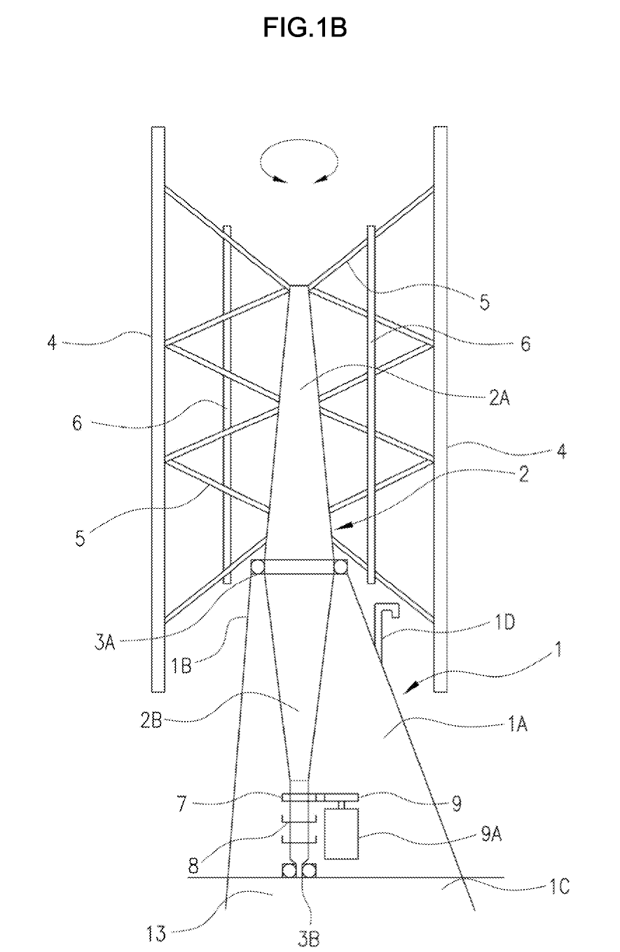

Therefore, it is preferable that the cross-sectional diameter of the rotating shaft 2 is maximum at the upper bearing 3A and gradually decreases toward upper and lower sides, resulting in a double truncated cone shape as in FIG. 1B. However, since machining is complicated, it may also have a uniform maximum cross-section as in FIG. 1A.

The lower bearing 3B may be installed between the upper bearing 3A and the concrete foundation 13. In this case, bending acting on the upper bearing 3A is the same, but a horizontal reaction force at the lower bearing 3B increases, which is disadvantageous.

The position of the lower bearing 3B is preferably at a lowest portion of the internal rotating shaft 2.

Bending of the upper portion 2A of the rotating shaft, which becomes maximum at the upper bearing 3A, acts as a horizontal load on an upper portion of the external fixed shaft 1.

Accordingly, the external fixed shaft 1 becomes a cantilever beam having a fixed end at a lower portion contacting the concrete foundation 13, supports the upper bearing 3A, and its bending increases toward a lower side and becomes maximum at a lowest portion contacting the concrete foundation 13. This is similar to a tower of a horizontal-axis wind turbine, but the height of the fixed shaft is reduced because the rotating shaft shares the load.

The shape of the fixed shaft is also a truncated cone having a wider lower portion, and resists large bending with a large cross-sectional area and a large section modulus at the lower portion.

As described above, the truncated cone of the fixed shaft is inclined to secure a large machine room space on one side between the lower portion 2B of the rotating shaft and the fixed shaft 1.

A length of the upper portion 2A of the internal rotating shaft above the position where the upper bearing 3A is installed and a length of the lower portion 2B can be adjusted, and may be regarded as roughly similar.

A power take-off gear 7 and a brake disk 8 are fixed to the lower portion 2B of the internal rotating shaft. A speed-increasing gear 9 for a generator is connected to the power take-off gear 7, and a speed-increasing gear 10 for heat conversion may also be connected.

A brake caliper 8C having a built-in hydraulic piston and a shoe pad 8D are installed on the brake disk 8. A shoe 8B may also be installed on a disk portion 8A so that it can be replaced or repaired when worn by friction.

A brake caliper support 8F is fixed to the external fixed shaft 1 or a floor of the concrete foundation 13. It is one of major advantages of this vertical-axis wind turbine that the brake disk 8 can be directly joined to the internal rotating shaft 2 and that multiple brake disks can be joined.

This is an advantage difficult to imagine in horizontal-axis wind turbines.

The heat-conversion speed-increasing gear 10 is connected to a heat conversion device such as a hydraulic type, overcurrent type, or water-stirring type. In the present invention, since a large machine room is secured by the inclined external fixed shaft 1, it is easy to install such a large heat conversion device.

Nevertheless, since it is expensive and complicated, the heat conversion device may be additionally considered when output control by the brake disk and caliper is difficult.

Output rotational speed control of the present invention includes:
(1) a method of adjusting a blade pitch angle by hydraulic pressure or the like, utilizing characteristics of a linear Darrieus wind turbine,
(2) a method of attaching a tail wing or an air brake to the supports or blades and adjusting it using hydraulic pressure or a servo motor,
(3) a method of appropriately clamping the brake disk with a caliper or shoe by hydraulic pressure or the like and converting output into thermal energy due to friction, and
(4) a method of providing an output gear other than a generator on the power take-off gear, increasing speed, and then driving a water agitator or the like to convert output into thermal energy.

Methods 1 and 2 are known methods. Method 1 is commonly used in horizontal-axis wind turbines and is applicable to the present invention, but it is complicated and expensive, and maintenance and repair are not easy because it is located at a high position.

Method 3 is the simplest, and maintenance and repair are easy because it is located at a low position. Since a brake is necessary in any case, additional cost is small if the brake also serves as an output control device. If one brake disk is insufficient, multiple brake disks may be installed, so this method is suitable for the present invention. Since high heat is generated, a cooling device such as water supply is needed, but this is also simple. A brake disk wall 8E is required so that cooling water does not drip down.

However, a countermeasure against damage due to generated steam is required. A steam outlet 1D of the present invention is one such countermeasure, and it is better to install an extractor as well. If cooling is performed by air, there is no significant damage, but the facility becomes oversized.

In offshore wind power, cooling water can be secured without limit, so there is no need to worry about steam generation.

Further, the shoe 8B and the shoe pad 8D wear severely, so they should always be maintained and replaceable.

The brake disk and caliper of the present invention are not substantially different in principle or structure from other brake disks and calipers, but differ in that they also serve as an output control device, are large, include the disk wall 8E, can be provided in multiple units, and include a water supply device 12.

In the drawings, the caliper is shown as clamping only from an upper side, but it may also clamp from both upper and lower sides like a typical caliper.

In this case, it is desirable to provide a wheel on a lower caliper to minimize friction, because heat transfer may be poor and overheating may occur. In this case, the brake caliper support 8F may also be small.

The generated heat may be recovered and used through water, but since complicated and expensive equipment is required, this would be possible only in special cases. In this method, it is very important and difficult to adjust a clamping strength of the caliper, but this can be solved with development of sensors and computers.

Method 4 requires additional components such as a clutch, a speed increaser, and a water agitator. If the speed increaser is a continuously variable gear, it is ideal, but a cooling tower may be required. It becomes complicated and expensive, which is problematic. It is ideal for recovering waste heat for use, but since it would be used rarely, practicality is questionable.

In addition to a water agitator, hydraulic or overcurrent types may also be used, but they are not suitable for large scale and are expensive. Of course, such equipment may be improved and used instead of a water agitator.

A large space at the lower portion of the external fixed shaft 1 of the present invention has a significant advantage in that large equipment such as a water agitator can be installed. Since it is unknown what equipment may be developed in the future, securing the space in advance is meaningful.

Although precise control is possible, it is complicated and expensive, so it may be additionally used when method 3 is insufficient.

What is claimed is:

1. A linear Darrieus vertical-axis wind power generation apparatus capable of large-scale manufacture, comprising:
a cylindrical internal rotating shaft installed vertically and supported by an upper bearing and a lower bearing;
a truncated cone-shaped external fixed shaft surrounding a lower portion of the internal rotating shaft, the external fixed shaft being eccentrically installed with an inclination to provide a space capable of being widely used as a machine room;
a power take-off gear and a brake disk installed at a lower portion of the internal rotating shaft; and
a vertical Warren truss in which the internal rotating shaft above the upper bearing and blades serve as chord members and tubular supports having an elliptical cross-section or a streamlined cross-section serve as web members.

2. The linear Darrieus vertical-axis wind power generation apparatus of claim 1, wherein vertical Savonius blades are joined to the supports in parallel with the internal rotating shaft and the blades, primarily for self-starting, and configured to reinforce the supports.

3. The linear Darrieus vertical-axis wind power generation apparatus of claim 1, wherein one or more brake disks each having a brake disk wall are fixed to the lower portion of the internal rotating shaft and are clamped by a brake caliper, and the linear Darrieus vertical-axis wind power generation apparatus includes a brake and output control device having a water supply device.

4. The linear Darrieus vertical-axis wind power generation apparatus of claim 1, wherein end portions or portions near ends of the supports at each level are mutually connected by horizontal wires so that a triangular or quadrilateral loop shape is formed.
